(19) United States
(12) Patent Application Publication
(10) Pub. No.: US 2015/0288814 A1
(43) Pub. Date: Oct. 8, 2015

(54) METHODS, DEVICES AND SYSTEMS FOR HANDLING BUSY LINE

(71) Applicant: Xiaomi Inc., Beijing (CN)

(72) Inventors: Daokuan Liu, Beijing (CN); Bin Wang, Beijing (CN); Haibin Weng, Beijing (CN)

(21) Appl. No.: 14/606,372

(22) Filed: Jan. 27, 2015

Related U.S. Application Data
(63) Continuation of application No. PCT/CN2014/091191, filed on Nov. 14, 2014.

(30) Foreign Application Priority Data
Apr. 3, 2014 (CN) 201410133887.1

(51) Int. Cl. H04M 3/42; H04M 3/436; H04M 1/725; H04W 4/16

(52) U.S. Cl. CPC H04M 3/42374; H04W 4/16; H04M 3/436; H04M 1/72563

(57) ABSTRACT

A method for a first terminal device to handle a busy line is provided. The method includes: sending a number query request when a second terminal device to which the first terminal device initiates a first call request is in a busy state; receiving a feedback on the number query request, wherein the feedback is provided based on a second call request initiated by the second terminal device; and if the feedback indicates that the second terminal device is calling the first terminal device, sending a connecting request to a server or sending a terminating request to one of the server and the second terminal device, wherein the connecting request indicates a request to connect the first terminal device with the second terminal device, and the terminating request indicates a request to terminate the second call request initiated by the second terminal device.

### CROSS-REFERENCE TO RELATED APPLICATIONS

This application is a continuation of international Application No. PCT/CN2014/091191, filed Nov. 14, 2014, which is based upon and claims priority to Chinese Patent Application No. 201410133887.1, filed Apr. 3, 2014, the entire contents of all of which are incorporated herein by reference.

### TECHNICAL FIELD

The present disclosure generally relates to the field of communication and, more particularly, to methods, devices and systems for handling a busy line.

### BACKGROUND

Voice communication is a basic function performed by a terminal device such as a smart phone, a tablet computer, a personal digital assistant (PDA), etc.

In a process of voice communication, a communication line may be busy if two terminal devices initiate call requests to each other at substantially the same time and, as a result, the voice communication may not be established. For example, when terminal device A initiates a call request to terminal device B, and at the same time, terminal device B is initiating a call request to terminal device A, the communication line between terminals A and B will be busy.

If two terminal devices repeatedly initiate call requests to each other at substantially the same time, the communication line will be busy, and the two terminal devices may not establish voice communication between each other. On the other hand, if each of the two terminal devices waits for a call request initiated by the other terminal device when the communication line is busy, it will take a longer period of time for the users of the two terminals to be able to communicate.

### SUMMARY

According to a first aspect of the present disclosure, there is provided a method for a first terminal device to handle a busy line, comprising: sending a number query request when a second terminal device to which the first terminal device initiates a first call request is in a busy state; receiving a feedback on the number query request, wherein the feedback is provided based on a second call request initiated by the second terminal device; and if the feedback indicates that the second terminal device is calling the first terminal device, sending a connecting request to a server or sending a terminating request to one of the server and the second terminal device, wherein the connecting request indicates a request to connect the first terminal device with the second terminal device, and the terminating request indicates a request to terminate the second call request initiated by the second terminal device.

According to a second aspect of the present disclosure, there is provided a method for handling a busy line, comprising: receiving a number query request sent by a first terminal device, wherein the number query request is sent by the first terminal device when a second terminal device to which the first terminal device initiates a first call request is in a busy state; and sending a feedback to the first terminal device based on a second call request initiated by the second terminal device, wherein the feedback indicates that the second terminal device is calling the first terminal device.

According to a third aspect of the present disclosure, there is provided a method for handling a busy line, comprising: receiving a terminating request sent by a first terminal device, wherein the terminating request is sent to a second terminal device by the first terminal device when a feedback received by the first terminal device from a server indicates that the second terminal device is calling the first terminal device; and terminating a call request initiated by the second terminal device in response to the terminating request.

According to a fourth aspect of the present disclosure, there is provided a first terminal device, comprising: a processor; and a memory for storing instructions executable by the processor. The processor is configured to: send a number query request when a second terminal device to which the first terminal device initiates a first call request is in a busy state; receive a feedback on the number query request, wherein the feedback is provided based on a second call request initiated by the second terminal device; and if the feedback indicates that the second terminal device is calling the first terminal device, send a connecting request to a server or sending a terminating request to one of the server and the second terminal device, wherein the connecting request indicates a request to connect the first terminal device with the second terminal device, and the terminating request indicates a request to terminate the second call request initiated by the second terminal device.

According to a fifth aspect of the present disclosure, there is provided a server, comprising: a processor; and a memory for storing instructions executable by the processor. The processor is configured to: receive a number query request sent by a first terminal device, wherein the number query request is sent by the first terminal device when a second terminal device to which the first terminal device initiates a first call request is in a busy state; and send a feedback to the first terminal device based on a second call request initiated by the second terminal device, wherein the feedback indicates that the second terminal device is calling the first terminal device.

According to a sixth aspect of the present disclosure, there is provided a second terminal device, comprising: a processor; and a memory for storing instructions executable by the processor. The processor is configured to: receive a terminating request sent by a first terminal device, wherein the terminating request is sent to the second terminal device by the first terminal device when a feedback received by the first terminal device from a server indicates that the second terminal device is calling the first terminal device; and terminate a call request initiated by the second terminal device in response to the terminating request.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of a system, according to an exemplary embodiment.

FIG. 2 is a flowchart of a method for handling a busy line, according to an exemplary embodiment.

FIG. 3 is a flowchart of a method for handling a busy line, according to an exemplary embodiment.

FIG. 4 is a flowchart of a method for handling a busy line, according to an exemplary embodiment.

FIG. 5 is a flowchart of a method for handling a busy line, according to an exemplary embodiment.

FIG. 6 is a flow diagram illustrating a method for handling a busy line, according to an exemplary embodiment.

FIG. 7 is a flow diagram illustrating a method for handling a busy line, according to an exemplary embodiment.

FIG. 8 is a flow diagram illustrating a method for handling a busy line, according to an exemplary embodiment.

FIG. 9 is a flow diagram illustrating a method for handling a busy line, according to an exemplary embodiment.

FIG. 10 is a diagram showing displays of a terminal device, according to an exemplary embodiment.

FIG. 11 is a flow diagram illustrating a method for handling a busy line, according to an exemplary embodiment.

FIG. 12 is a diagram showing a display of a terminal device, according to an exemplary embodiment.

FIG. 13 is a flow diagram illustrating a method for handling a busy line, according to an exemplary embodiment.

FIG. 14 is a diagram showing a display of a terminal device, according to an exemplary embodiment.

FIG. 15 is a flow diagram illustrating a method for handling a busy line, according to an exemplary embodiment.

FIG. 16 is a diagram showing displays of a terminal device, according to exemplary embodiments.

FIG. 17 is a diagram showing a display of a terminal device, according to an exemplary embodiment.

FIG. 18 is a block diagram of a device for handling a busy line, according to an exemplary embodiment.

FIG. 19 is a block diagram of a device for handling a busy line, according to an exemplary embodiment.

FIG. 20 is a block diagram of a device for handling a busy line, according to an exemplary embodiment.

FIG. 21 is a block diagram of a device for handling a busy line, according to an exemplary embodiment.

FIG. 22 is a block diagram of a device for handling a busy line, according to an exemplary embodiment.

FIG. 23 is a block diagram of a device for handling a busy line, according to an exemplary embodiment.

FIG. 24 is a block diagram of a device for handling a busy line, according to an exemplary embodiment.

FIG. 25 is a block diagram of a device for handling a busy line, according to an exemplary embodiment.

FIG. 26 is a block diagram of a device for handling a busy line, according to an exemplary embodiment.

FIG. 27 is a block diagram of a server, according to an exemplary embodiment.

FIG. 28 is a block diagram of a terminal device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

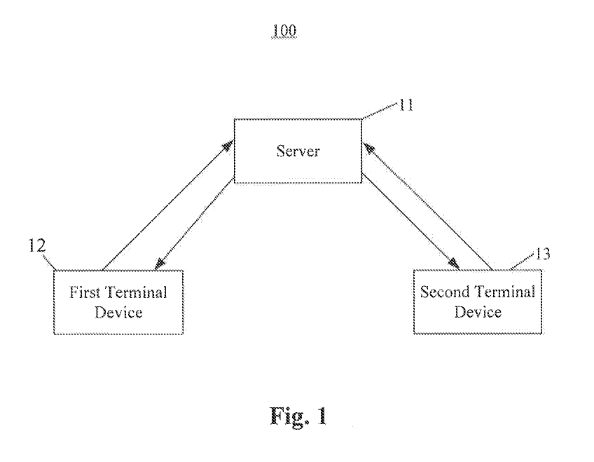

FIG. 1 is a schematic diagram illustrating a system 100 for handling a busy line, according to an exemplary embodiment. Referring to FIG. 1, the system 100 includes a server 11, a first terminal device 12, and a second terminal device 13. The server 11 is connected to the first terminal device 12 and the second terminal device 13.

The server 11 may be a switch, a server cluster consisting of multiple servers, a cloud computation service center, or the like. The server 11 is configured to provide communication services to client devices, such as first terminal device 12 and second terminal device 13.

The first terminal device 12 and the second terminal device 13 may each be mobile communication equipment, a mobile phone, a PDA, an electronic book reader, a Moving Picture Experts Group Audio Layer III (MP3) player, a Moving Picture Experts Group Audio Layer IV (MP4) player, a laptop portable computer, a desktop computer and so on.

The server 11 may be connected with the first terminal device 12 and the second terminal device 13 via a wireless or wired network.

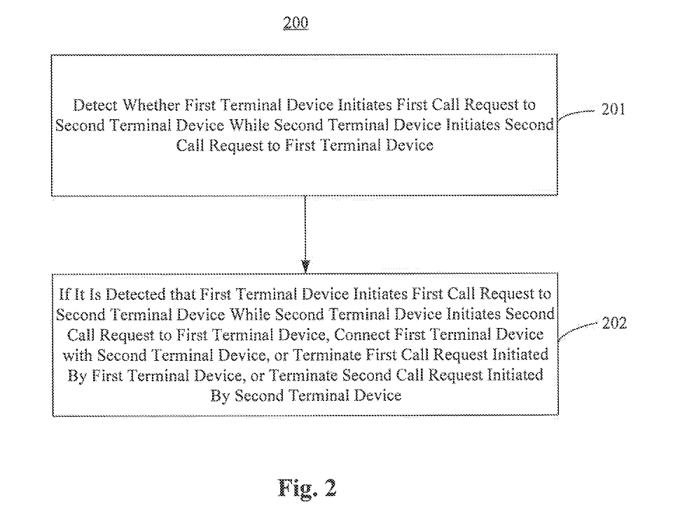

FIG. 2 is a flowchart of a method 200 for handling a busy line, according to an exemplary embodiment. For example, the method 200 may be performed by the server 11 shown in FIG. 1. Referring to FIG. 2, the method 200 may include the following steps.

In step 201, the server detects whether a first terminal device initiates a first call request to a second terminal device while the second terminal device initiates a second call request to the first terminal device.

In step 202, if it is detected that the first terminal device initiates the first call request to the second terminal device while the second terminal device initiates the second call request to the first terminal device, the server connects the first terminal device with the second terminal device, or terminate the first call request initiated by the first terminal device, or terminate the second call request initiated by the second terminal device.

By connecting the first terminal device with the second terminal device, or terminating the call request initiated by the first or second terminal device, communication efficiency may be improved and unnecessary waiting time can be avoided if two terminal devices initiate call requests to each other at substantially the same time.

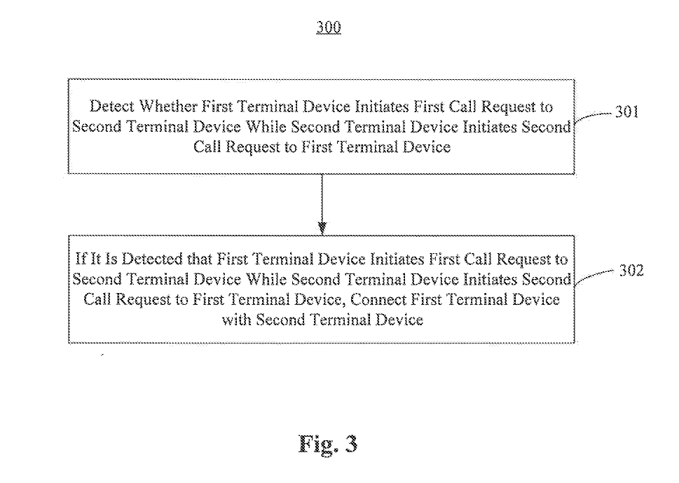

FIG. 3 is a flowchart of a method 300 for handling a busy line according to an exemplary embodiment. For example, the method 300 may be performed by the server 11 shown in FIG. 1. Referring to FIG. 3, the method 300 may include the following steps.

In step 301, the server detects whether a first terminal device initiates a first call request to a second terminal device while the second terminal device initiates a second call request to the first terminal device.

For example, the server may detect whether a number in the first call request initiated by the first terminal device is a number associated with the second terminal device, and whether a number in the second call request initiated by the second terminal device is a number associated with the first terminal device.

In step 302, if it is detected that the first terminal device initiates the first call request to the second terminal while the second terminal device initiates the second call request to the first terminal device, the server connects the first terminal device with the second terminal device.

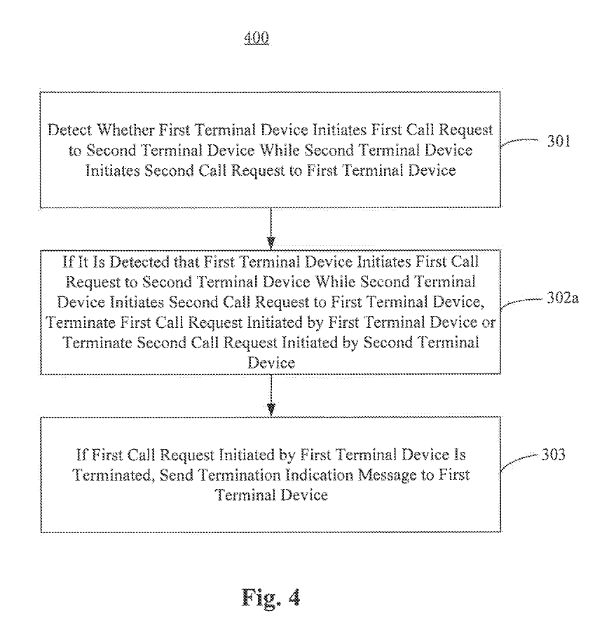

FIG. 4 is a flowchart of a method 400 for handling a busy line, according to an exemplary embodiment. Referring to FIG. 4, the method 400 includes step 301 which is described above in connection with FIG. 3.

In step 302a, if the server detects that the first terminal device initiates the first call request to the second terminal device while the second terminal device initiates the second call request to the first terminal device, the server terminates the first call request initiated by the first terminal device or terminates the second call request initiated by the second terminal device.

In some embodiments, the server may determine an initiating time of the first call request and an initiating time of the second call request. For example, if the initiating time of the call request initiated by terminal A is earlier than that of the call request initiated by terminal B, and the server determines that the initiating time of the call request initiated by terminal B is later than that of the call request initiated by terminal A, the server may terminate the call request initiated by terminal B. Alternatively, the server may terminate the call request initiated by terminal A.

In step 303, if the server terminates the first call request initiated by the first terminal device, the server sends a termination indication message to the first terminal device. The termination indication message notifies the first terminal device not to continue initiating the first call request to the second terminal device.

For example, if the initiating time of the call request initiated by terminal A to terminal B is later than that of the call request initiated by terminal B to terminal A, the server may terminate the call request initiated by terminal A to terminal B, and send a termination indication message to terminal A, notifying terminal A not to continue initiating the call request to terminal B.

By terminating the first call request initiated by the first terminal device, the second terminal device may be connected with the first terminal device, and communication between the first and second terminal devices may be established.

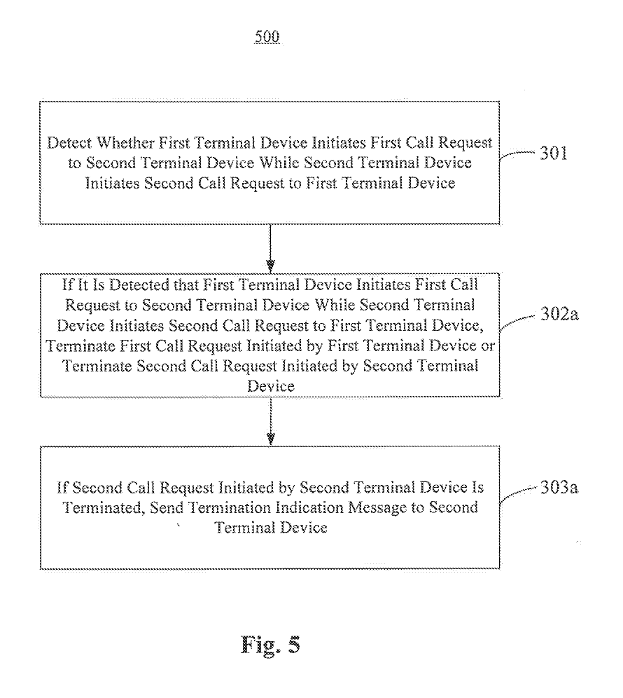

FIG. 5 is a flowchart of a method 500 for handling a busy line, according to an exemplary embodiment. Referring to FIG. 5, the method 500 includes steps 301 and 302a, which are described above in connection with FIG. 4.

In step 303a, if the server terminates the second call request initiated by the second terminal device, the server may send a termination indication message to the second terminal device. The termination indication message notifies the second terminal device not to continue initiating the second call request.

By terminating the second call request initiated by the second terminal device, the first terminal device may be connected with the second terminal device, and communication between the first and second terminal devices may be established.

In the above embodiments, by terminating the call request initiated by the first or second terminal device, communication efficacy can be improved and unnecessary waiting time can he avoided when two terminal devices initiate call requests to each other at substantially the same time.

By sending a termination indication message to one of the first terminal device and the second terminal device, the call request of which is terminated, the communication line can be prevented from being continuously busy in the calling process, and communication between the first and second terminal devices may be established.

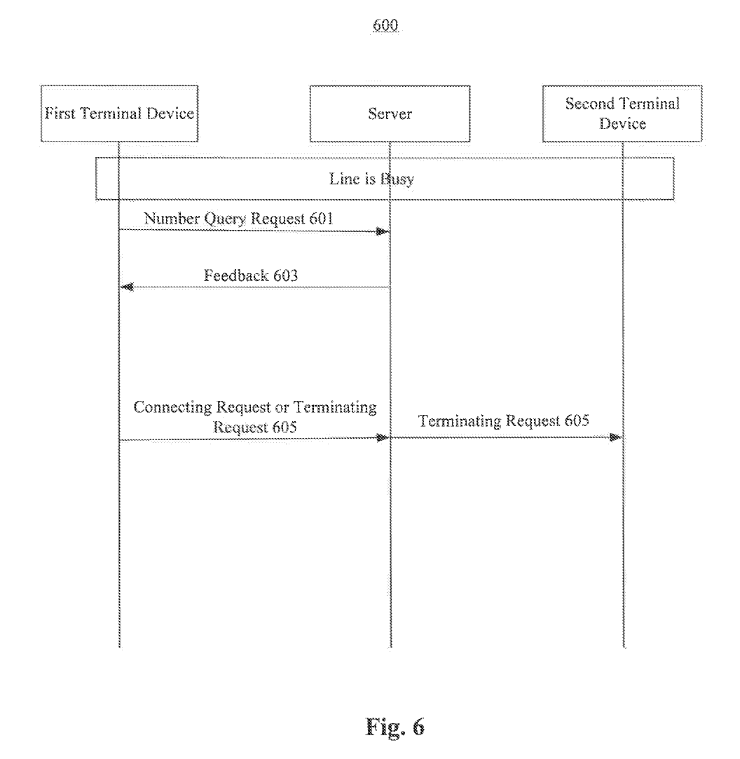

FIG. 6 is a flow diagram for illustrating a method 600 for handling a busy line, according to an exemplary embodiment. For example, the method 600 may be implemented in the system 100 illustrated in FIG. 1. Referring to FIG. 6, the method 600 may include the following steps.

In step 601, a first terminal device sends a number query request to a server, when a second terminal device that is called by the first terminal device is in a busy state due to, e.g., initiating a call request.

For example, terminal A is the first terminal device, and terminal B is the second terminal device. Terminal A and terminal B may each be mobile communication equipment, or fixed communication equipment.

When terminal B is in a busy state, terminal A sends a number query request to the server.

In step 603, after receiving the number query request, the server sends a feedback to the first terminal device based on a call request initiated by the second terminal device.

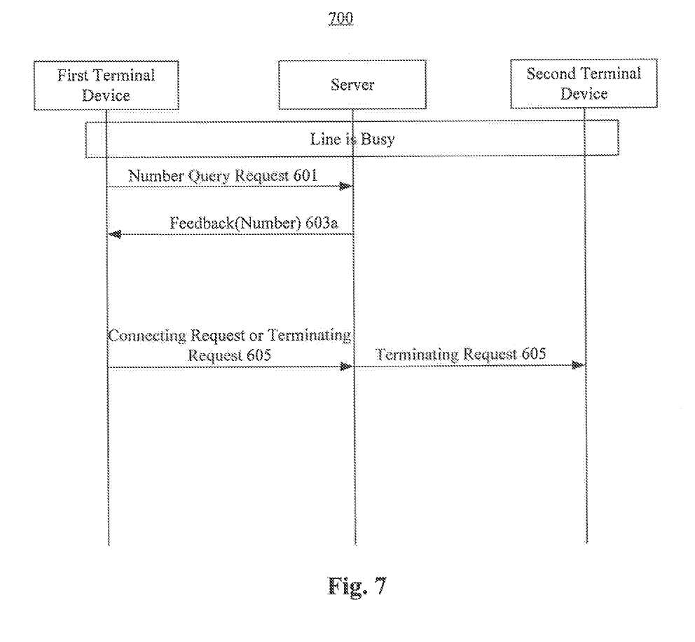

In some embodiments, the feedback sent by the server may include a number in the call request initiated by the second terminal device. FIG. 7 is a flow diagram illustrating a method 700 for handling a busy line, according to an exemplary embodiment. As shown in FIG. 7, in step 603a, the server sends a feedback including a number in the call request initiated by the second terminal device to the first terminal device.

For example, suppose terminal A is the first terminal device, and terminal B is the second terminal device, the server may include a number called by terminal B in the feedback to terminal A.

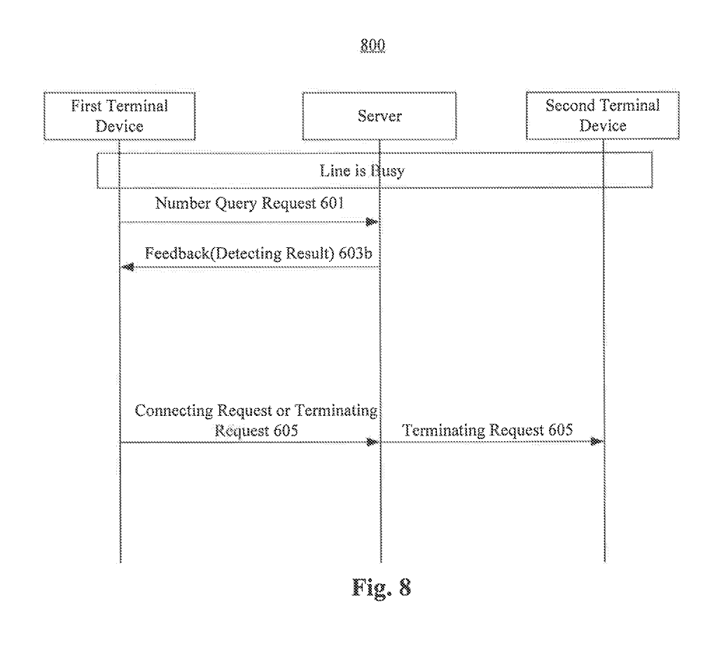

In other embodiments, the server may detect whether the number in the call request initiated by the second terminal device is a number associated with the first terminal device and include the detecting result in the feedback. FIG. 8 is a flow diagram illustrating a method 800 for handling a busy line, according to an exemplary embodiment. As shown in FIG. 8, in step 603b, the server sends a feedback including a detecting result to the first terminal device.

For example, suppose terminal A is the first terminal device, and terminal B is the second terminal device, the server may detect whether a number called by terminal B is the number of terminal A, and send a detecting result to terminal A through the feedback. In doing so, leakage of private information of the second terminal device may be prevented.

Referring back to FIG. 6, the first terminal device receives the feedback on the number query request from the server.

In step 605, if the feedback indicates that the second terminal device is calling the first terminal device, the first terminal device may send a connecting request to the server, Alternatively or in addition, the first terminal device may send a terminating request to the server or the second terminal device.

For example, the connecting request is used for requesting the server to connect the first terminal device with the second terminal device. Also for example, the terminating request is used for requesting termination of the call request initiated by the second terminal device.

By sending a connecting request to the server or sending a terminating request to terminate a call request initiated by a called terminal device, communication between the two terminal devices may he established when the two terminal devices initiate call requests to each other at substantially the same time.

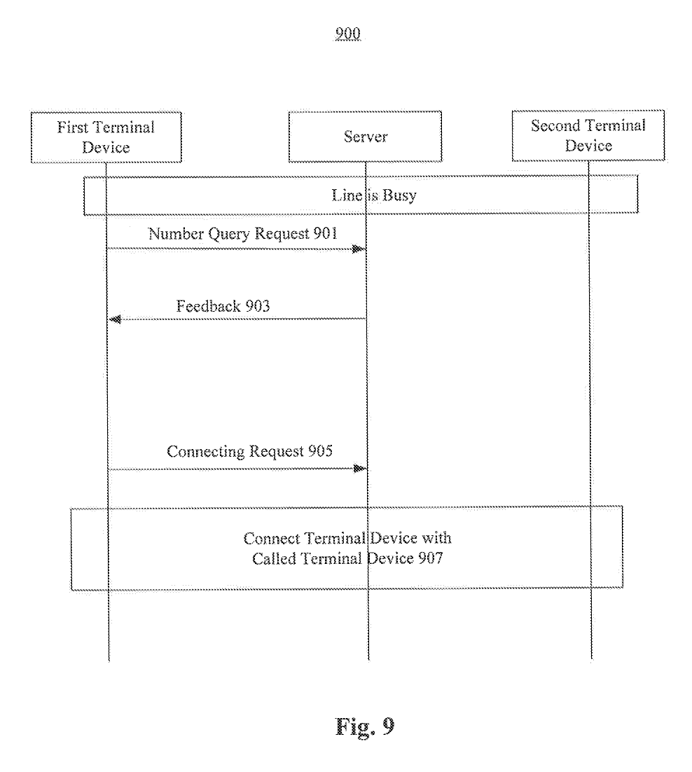

FIG. 9 is a flow diagram illustrating a method 900 for handling a busy line, according to an exemplary embodiment. For example, the method 900 may he implemented in the system 100 illustrated in FIG. 1. Referring to FIG. 9, the method 900 may include the following steps.

In step 901, a first terminal device may send a number query request to a server, when a second terminal device that is called by the first terminal device is in a busy state due to, e.g., initiating a call request.

For example, terminal A is the first terminal device, and terminal B is the second terminal device. Terminal A and terminal B may each be mobile communication equipment, or fixed communication equipment.

When terminal B is in a busy state, terminal A may send a number query request to the server.

In step 903, the server sends a feedback to the first terminal device based on a call request initiated by the second terminal device.

In some embodiments, the server may include in the feedback a number in the call request initiated by the second terminal device.

In other embodiments, the server may detect whether the number in the call request initiated by the second terminal device is a number of the first terminal device, and send a feedback including the detecting result to the first terminal device.

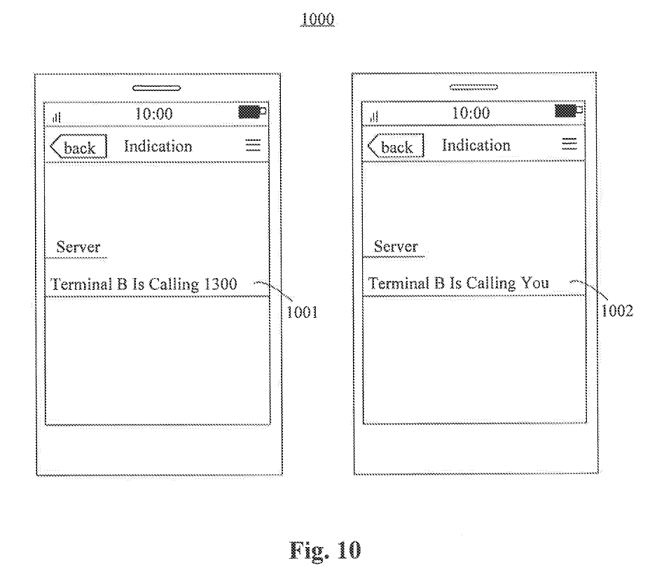

In some embodiments, the feedback may include the number in the call request initiated by the second terminal device, and the first terminal device may display the feedback on a display interface of the first terminal device. FIG. 10 is a diagram showing displays of feedbacks on a display interface 1000 of terminal device A, according to exemplary embodiments.

In one exemplary embodiment, terminal device A receives the called number of terminal B sent by the server, the number of terminal A is 1300, and the called number of terminal B is the number of terminal A. A feedback 1001 from the server received by terminal A indicates, e.g., “Terminal B is calling 1300”, and is displayed on terminal A.

In another embodiment, terminal device A receives a feedback 1002 including a detecting result sent by the server. The server obtains the detecting result by detecting the called number of terminal B which indicates that terminal B is calling terminal A in this example. The feedback 1002 received by terminal A indicates, e.g., “Terminal B is calling you”, and is displayed on terminal A.

Referring back to FIG. 9, in step 905, if the feedback indicates that the second terminal device is calling the first terminal device, the first terminal device sends a connecting request to the server. For example, the connecting request is used for requesting the server to connect the first terminal device with the second terminal device.

In step 907, the server connects the first terminal device with the second terminal device in response to receiving the connecting request.

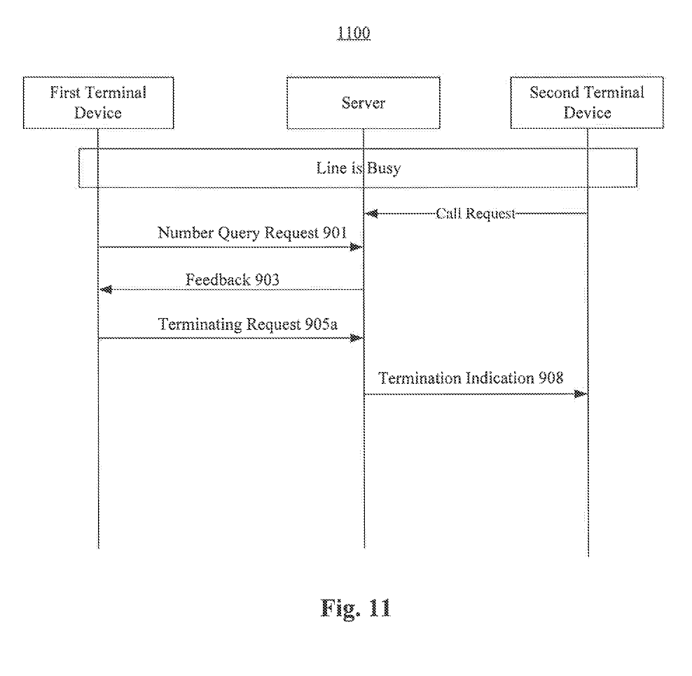

FIG. 11 is a flow diagram illustrating a method 1100 for handling a busy line, according to an exemplary embodiment. Referring to FIG. 11, the method 1100 includes steps 901 and 903, which are described above in connection with FIG. 9.

In step 905a, the terminal device sends a terminating request to the server if the feedback indicates that the second terminal device is calling the first terminal device. For example, the terminating request is used for requesting the server to terminate the call request initiated by the second terminal device. After receiving the terminating request, the server may terminate the call request initiated by the second terminal device.

In step 908, the server may send a termination indication message to the second terminal device. For example, the termination indication message is used for notifying the second terminal device not to continue initiating the call request.

For example, if the call request initiated by terminal B is to he terminated by the server, the server may send a termination indication message to terminal B. The termination indication message may be displayed on terminal B, and a user using terminal B may temporarily stop initiating the call request to terminal A after viewing the termination indication message. In some embodiments, terminal B may automatically temporarily stops initiating the call request to terminal A in response to receiving the termination indication message.

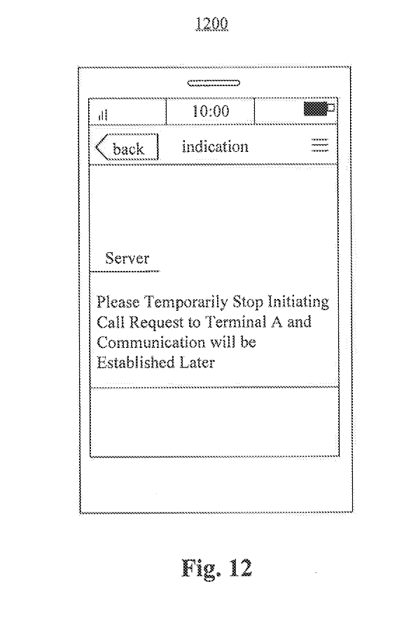

FIG. 12 is a diagram illustrating a termination indication message being displayed on a display interface 1200 of a terminal device, according to an exemplary embodiment. For example, the termination indication message is sent by a server to terminal B. Also for example, the termination indication message may be a message “Please Temporarily Stop Initiating Call Request to Terminal A and Communication will be Established Later,” Terminal B may stop initiating the call request to terminal A in response to the termination indication message.

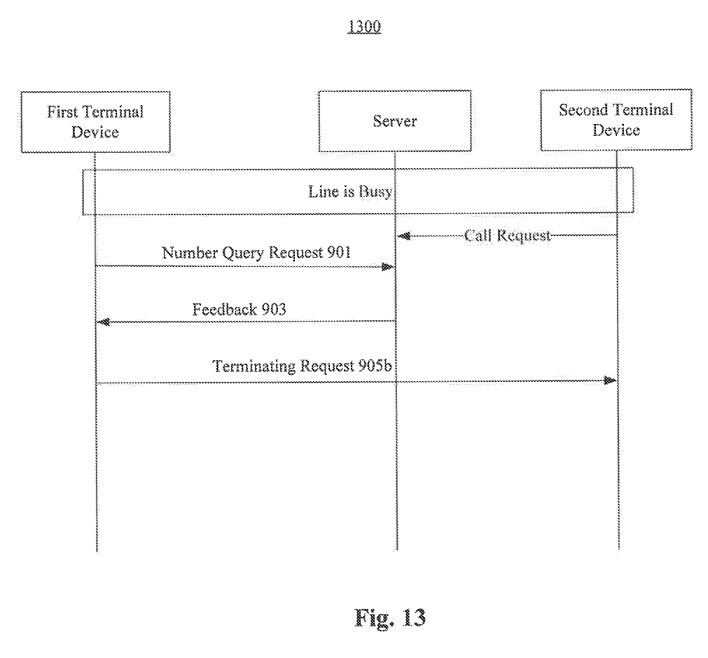

FIG. 13 is a flow diagram illustrating a method 1300 for handling a busy line, according to an exemplary embodiment. Referring to FIG. 13, the method 1300 includes steps 901 and 903, which are described above in connection with FIG. 9.

In step 905b, the first terminal device sends a terminating request to the second terminal device if the feedback indicates that the second terminal device is calling the first terminal device. For example, the terminating request is used for requesting the second terminal device to terminate the call request initiated by the second terminal device. After receiving the terminating request message, the second terminal device terminates the initiated call request.

In some embodiments, after receiving the terminating request, the second terminal device may automatically terminate the initiated call request.

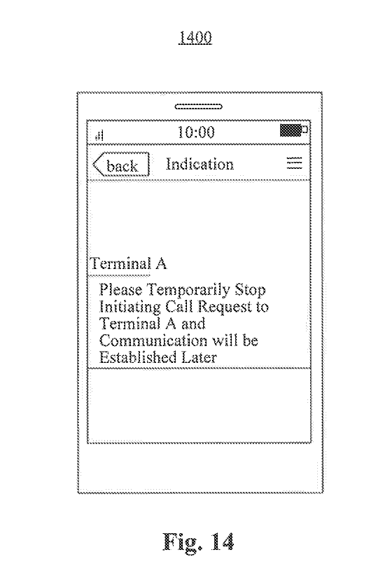

In other embodiments, after receiving the terminating request, the terminating request may be displayed on the second terminal device. Subsequently, the second terminal device may receive a user input signal on the terminating request and terminate the initiated call request according to the user input signal. FIG. 14 is a diagram showing terminating request sent by terminal A being displayed on a display interface 1400 of a terminal device, according to an exemplary embodiment.

By terminating the call request initiated by the second terminal device, the first terminal device may be connected with the second terminal device, and communication may be conducted between the two terminal devices.

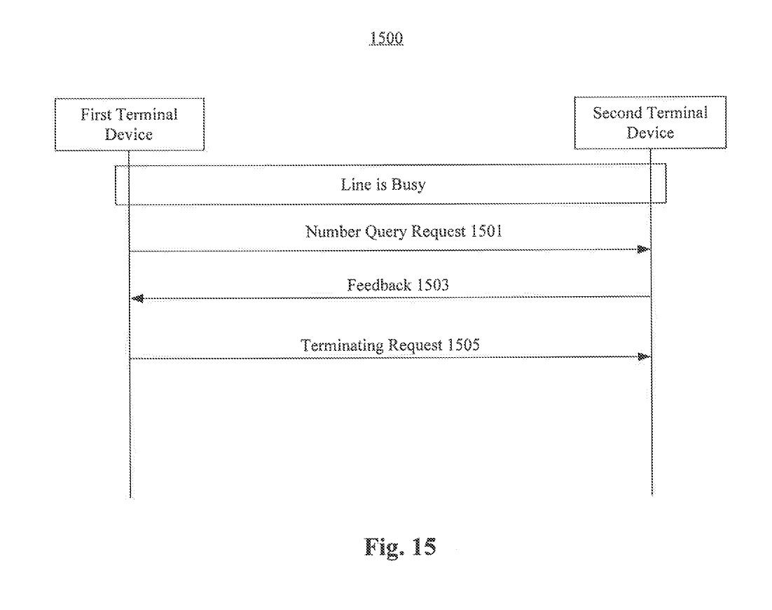

FIG. 15 is a flow diagram illustrating a method 1500 for handling a busy line, according to an exemplary embodiment. The method 1500 may be implemented in the system 100 illustrated in FIG. 1. Referring to FIG. 15, the method 1500 may include the following steps.

In step 1501, a first terminal device sends a number query request to a second terminal device to which the first terminal is initiating a call request, when the second terminal device is in a busy state due to, e.g., also initiating a call request.

In some embodiments, the number query request may be sent by the first terminal device to the second terminal device through a server. Correspondingly, the second terminal device receives the number query request from the first terminal device through the server.

In other embodiments, the number query request may be directly sent to the second terminal device from the first terminal device. Correspondingly, the second terminal device receives the number query request from the first terminal device directly.

In step 1503, the second terminal device sends a feedback to the first terminal device based on a call request initiated by the second terminal device.

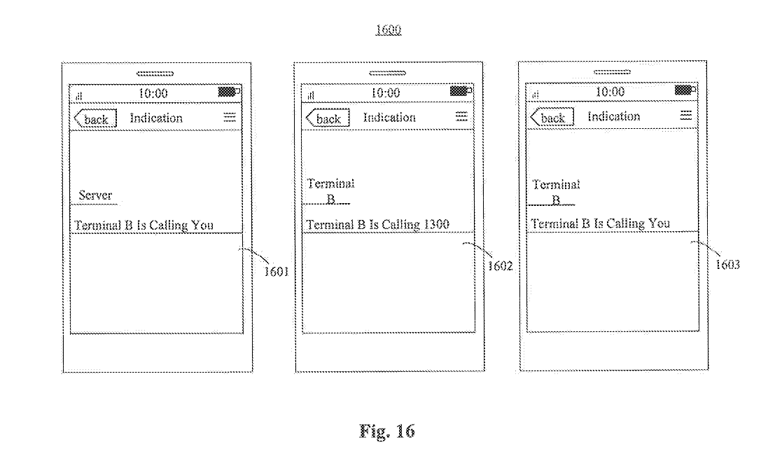

In some embodiments, the second terminal device may send a feedback including a number in the call request initiated by the second terminal device to the first terminal device, directly or through the server. In other embodiments, the second terminal device may detect whether the number in the call request initiated by the second terminal device is a number associated with the first terminal device, and send a feedback including the detecting result to the first terminal device, directly or through the server. FIG. 16 is a diagram showing feedbacks displayed on a display interface 1600 of a terminal device, according to exemplary embodiments.

In one exemplary embodiment, if the number query request is sent by the first terminal device to the second terminal device through the server, the server may detect whether the number in the call request initiated by the second terminal device is the number associated with the first terminal device, and send a feedback to the first terminal device including the detecting result. For example, terminal A receives a feedback 1601 carrying a detecting result sent by the server, where the server obtains the detecting result by detecting the called number of terminal B. If the detecting result indicates that terminal B is calling terminal A, the feedback 1601 received by terminal A may indicate, e.g., “Terminal B Is Calling You”, and may be displayed on terminal A.

In one exemplary embodiment, if the number query request is directly sent to the second terminal device, the second terminal device may send a feedback to the first terminal device, including the number in the call request initiated by the second terminal device. For example, terminal A receives the called number of terminal B from terminal B, and the number of terminal A is 1300. If the called number of terminal B is the number of terminal A, terminal B may send a feedback 1062 to terminal A indicating, e.g., “Terminal B Is Calling 1300”. The feedback 1602 sent by terminal B may be displayed on terminal A.

In one exemplary embodiment, if the number query request is directly sent to the second terminal device, the second terminal device may send a feedback including a detecting result to the first terminal device. The server or the second terminal device may obtain the detecting result by detecting whether the number in the call request initiated by the second terminal device is the number associated with the terminal device. For example, terminal A receives a feedback 1603 including a detecting result from terminal B, where terminal B obtains the detecting result by detecting the called number of terminal B. If the detecting result indicates that terminal B is calling terminal A, the feedback 1603 received by terminal A may indicate, e.g., “Terminal B Is Calling You”. The feedback 1603 sent by terminal B may be displayed on terminal A.

Referring to FIG. 15, in step 1505, if the feedback indicates that the second terminal device is calling the first terminal device, the first terminal device sends a terminating request to the second terminal device. For example, the terminating request is used for requesting the second terminal device to terminate the initiated call request. Accordingly, the second terminal device may terminate the initiated call request in response to receiving the terminating request from the first terminal device.

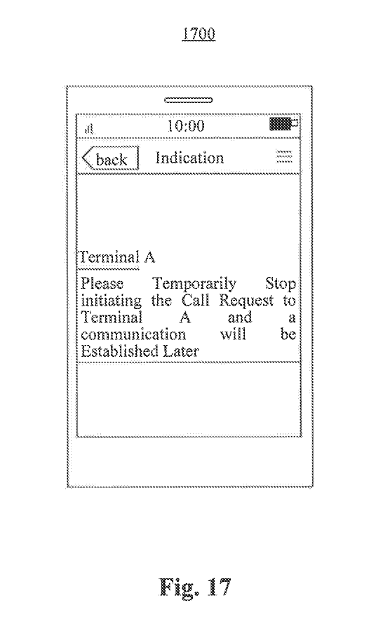

FIG. 17 is a diagram illustrating a terminating request message being displayed on a display interface 1700 of terminal device B, according to an exemplary embodiment. As shown in FIG. 17, terminal B displays the terminating request message sent by terminal A. For example, the terminating request message may be a message “Please Temporarily Stop Initiating the Call Request to Terminal A, and a Communication will be Established later,” Subsequently, Terminal B may stop initiating the call request to terminal A according to the terminating request message.

By terminating the call request initiated by the second terminal device, the first terminal device may be connected with the second terminal device, and communication may be conducted between the two terminal devices.

In the method 1500, the number query request and the terminating request may be directly sent between the first terminal device and the second terminal device, or through a network.

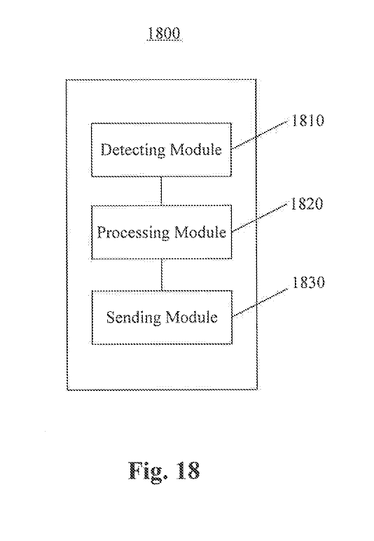

FIG. 18 is a block diagram of a device 1800 for handling a busy line, according to an exemplary embodiment. The device 1800 may be implemented to be all or a part of a server by hardware, software, or a combination thereof. Referring to FIG. 18, the device 1800 may include a detecting module 1810, a processing module 1820, and a sending module 1830.

The detecting module 1810 is configured to detect whether a first terminal device initiates a first call request to a second terminal device while the second terminal device initiates a second call request to the first terminal device.

The processing module 1820 is configured to connect the first terminal device with the second terminal device, or terminate the first call request initiated by the first terminal device, or terminate the second call request initiated by the second terminal device, if the detecting module 1810 detects that the first terminal device initiates the first call request to the second terminal device while the second terminal device initiates the second call request to the first terminal device.

In some embodiments the detecting module 1810 is further configured to detect whether a number in the first call request initiated by the first terminal device is a number associated with the second terminal device, and whether a number in the second call request initiated by the second terminal device is a number associated with the first terminal device.

The sending module 1830 may be configured to send a termination indication message to the first or second terminal device after the first call request initiated by the first terminal or the second call request initiated by the second device is terminated by the processing module 1820. The termination indication message is used for notifying the terminal device not to continue initiating the call request to the other terminal device.

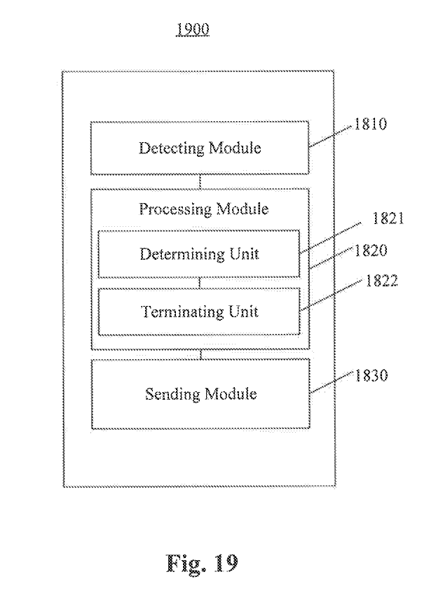

FIG. 19 is a block diagram of a device 1900 for handling a busy line, according to an exemplary embodiment. Referring to FIG. 19, the device 1900 may include the detecting module 1810, the processing module 1820, and the sending module 1830 (FIG. 18). The processing module 1820 may include a determining unit 1821 and a terminating unit 1822. The determining unit 1821 is configured to determine between a first call request and a second call request whose initiating time is later based on an initiating time of the first call request and an initiating time of the second call request. The terminating unit 1822 is configured to terminate the first or second call request based on the initiating time of the first call request and the initiating time of the second call request.

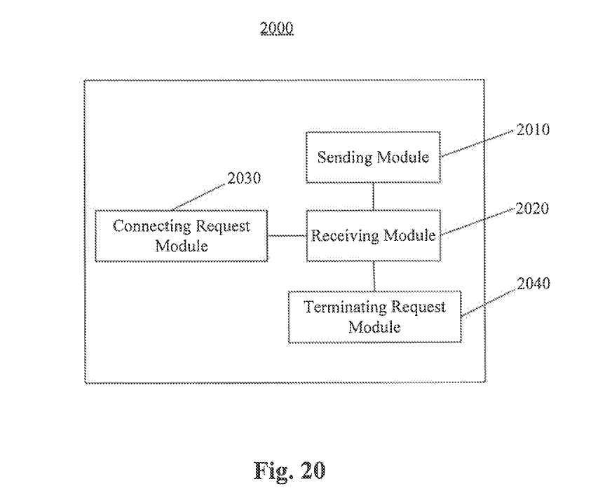

FIG. 20 is a block diagram of a device 2000 for handling a busy line, according to another exemplary embodiment. The device 2000 may be implemented to be all or a part of a first terminal device by hardware, software, or a combination thereof. Referring to FIG. 20, the device 2000 may include a sending module 2010, a receiving module 2020, a connecting request module 2030, and a terminating request module 2040.

The sending module 2010 is configured to send a number query request when a second terminal device that is called by the first terminal device is in a busy state.

The receiving module 2020 is configured to receive a feedback on the number query request. The feedback may be provided based on a call request initiated by the second terminal device.

The connecting request module 2030 is configured to send a connecting request to a server if the feedback indicates that the second terminal device is calling the first terminal device, The connecting request is used for requesting the server to connect the first terminal device with the second terminal device. The terminating request module 2040 is configured to send a terminating request to the server or the second terminal device. The terminating request is used for requesting the second terminal device to terminate the call request initiated by the second terminal device.

In some embodiments, the receiving module 2020 is further configured to receive a feedback sent by the server if the number query request is sent to the server. The feedback may include a number in the call request initiated by the second terminal device.

In some embodiments, the receiving module 2020 is further configured to receive a feedback including a detecting result sent by the server. The server obtains the detecting result by detecting whether the number in the call request initiated by the second terminal device is a number associated with the first terminal device.

In some embodiments, the receiving module 2020 is further configured to receive a feedback including a detecting result sent by the server if the number query request is sent to the second terminal device through the server. The second terminal device may obtain the detecting result by detecting whether the number in the call request initiated by the second terminal device is a number associated with the first terminal device.

In some embodiments, the receiving module 2020 is further configured to receive a feedback sent by the second terminal device if the number query request is directly sent to the second terminal device. The feedback includes the number in the call request initiated by the second terminal device.

In some embodiments, the receiving module 2020 is further configured to receive a feedback including a detecting result sent by the second terminal device if the number query request is directly sent to the second terminal device. The server or the second terminal device may obtain the detecting result by detecting whether the number in the call request initiated by the second terminal device is a number associated with the first terminal device.

The device 2000 allows the first terminal device to send a number query request to a server, receive a feedback from the server, and send a connecting request to the server based on the feedback to establish a communication. In doing so, the two terminal devices may be connected by the server, or the call request initiated by the second terminal device may be terminated, if two terminal devices initiate call requests to each other. Moreover, the first terminal device may detect whether a call number of the second terminal device is a number associated with the first terminal device by a number query request. If the second terminal device is not calling the first terminal device, the first terminal device may terminate the call request of the first terminal device based on the feedback sent by the server.

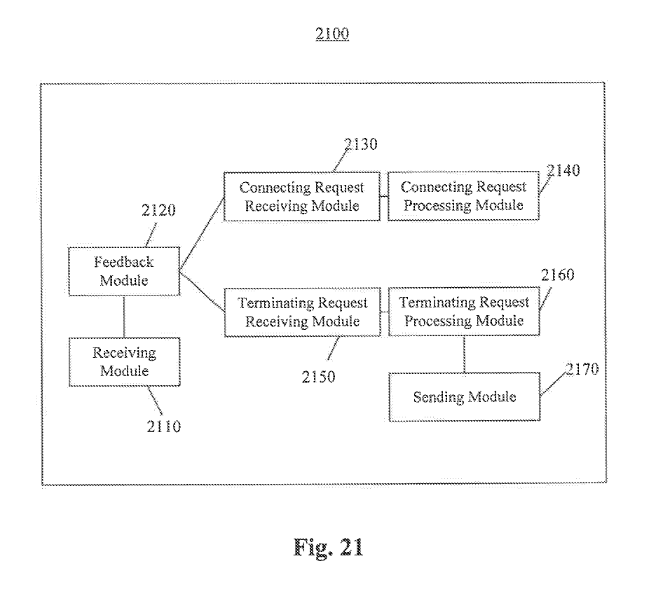

FIG. 21 is a block diagram of a device 2100 for handling a busy line, according to an exemplary embodiment. The device 2100 may be implemented to be all or a part of a server by hardware, software, or a combination thereof. Referring to FIG. 21, the device 2100 may include a receiving module 2110, a feedback module 2120, a connecting request receiving module 2130, a connecting request processing module 2140, a terminating request receiving module 2150, a terminating request processing module 2160, and a sending module 2170.

The receiving module 2110 is configured to receive a number query request sent by a first terminal device. The number query request is sent by the first terminal device when a second terminal device that is called by the first terminal device is in a busy state.

The feedback module 2120 is configured to send a feedback to the first terminal device based on a call request initiated by the second terminal device. The feedback is used for triggering the first terminal device to send a connecting request to the server if the feedback indicates that the second terminal device is calling the first terminal device. The connecting request is used for requesting the server to connect the first terminal device with the second terminal device. The feedback may also be used for triggering the first terminal device to send a terminating request to the server or the second terminal device. The terminating request is used for requesting the server or the second terminal device to terminate the call request initiated by the second terminal device.

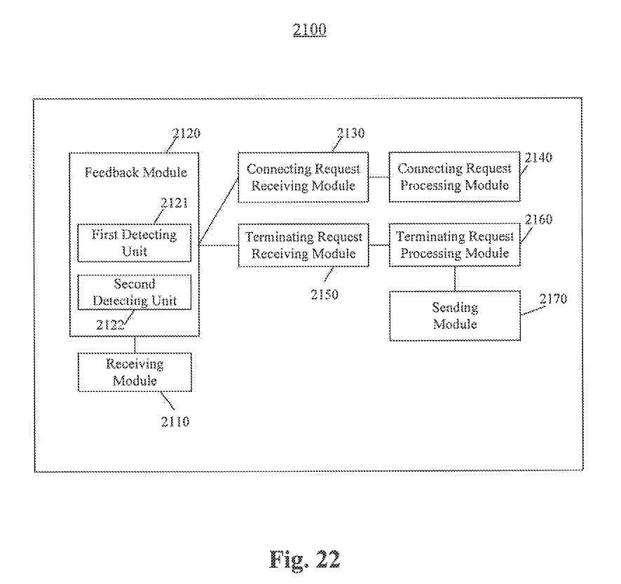

In one exemplary embodiment, as shown in FIG. 22, the feedback module 2120 may further include a first feedback unit 2121 and a second feedback unit 2122.

The first feedback unit 2121 is configured to send a feedback including a number in the call request initiated by the second terminal device to the first terminal device.

The second feedback unit 2122 is configured to detect whether the number in the call request initiated by the second terminal device is a number associated with the first terminal device, and for sending a feedback including the detecting to the first terminal device.

Referring back to FIG. 21, the connecting request receiving module 2130 is configured to receive a connecting request sent by the first terminal device. The connecting request is sent to the server by the first terminal device if the feedback indicates that the second terminal device is calling the first terminal device.

The connecting request processing module 2140 is configured to connect the first terminal device with the second terminal device based on the connecting request received by the connecting request receiving module 2130.

The terminating request receiving module 2150 is configured to receive a terminating request sent by the first terminal device. The terminating request is sent to the server by the first terminal device if the feedback indicates that the second terminal device is calling the first terminal device,

The terminating request processing module 2160 is configured to terminate the call request initiated by the second terminal device in response to the terminating request received by the terminating request receiving module 2150.

The sending module 2170 is configured to send a termination indication message to the second terminal device after the call request initiated by the second terminal device is terminated by the terminating request processing module 2160. The termination indication message is used for notifying the second terminal device not to continue initiating the call request.

The device 2100 allows the first terminal device to send a number query request to the server, receive a feedback sent by the server, and send a terminating request to the server or the second terminal device if the feedback indicates that the second terminal device is calling the first terminal device. In doing so, if two terminal devices initiate call requests to each other, the call request initiated by one of the two terminal devices may be terminated such that the two terminal devices may be connected by the server.

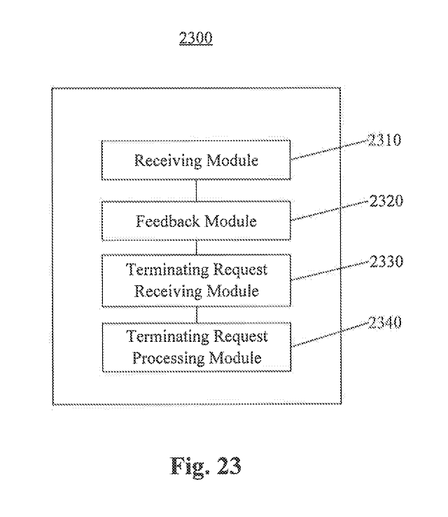

FIG. 23 is a block diagram of a device 2300 for handling a busy line, according to an exemplary embodiment. The device 2300 may be implemented to be all or a part of a second terminal device by hardware, software, or a combination thereof. Referring to FIG. 23, the device 2300 may include a receiving module 2310, a feedback module 2320, a terminating request receiving module 2330, and a terminating request processing module 2340.

The receiving module 2310 is configured to receive a number query request sent by a first terminal device. The number query request is sent by the first terminal device When the first terminal device calls the second terminal device and the second terminal device is in a busy state.

The feedback module 2320 is configured to send a feedback to the first terminal device based on a call request initiated by the second terminal device. The feedback is used for triggering the first terminal device to send a connecting request to a server if the feedback indicates that the second terminal device is calling the first terminal device. The connecting request is used for requesting the server to connect the first terminal device with the second terminal device. The feedback may also be used for triggering the first terminal device to send a terminating request to the server or the second terminal device. The terminating request is used for requesting the server or the second terminal device to terminate the call request initiated by the second terminal device.

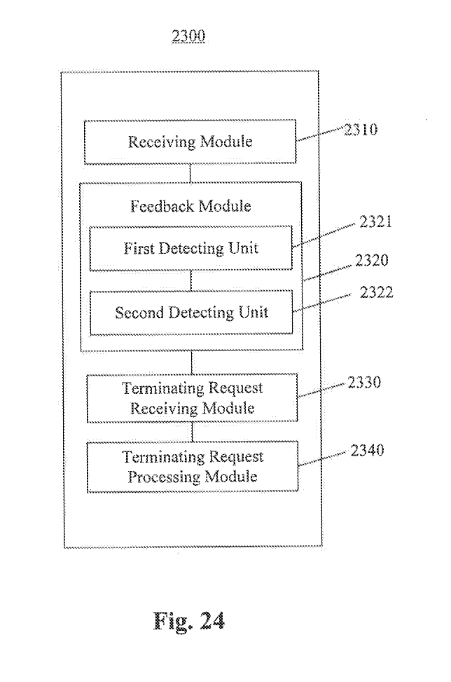

In one exemplary embodiment, shown in FIG. 24, the feedback module 2320 may further include a first feedback unit 2321 and a second feedback unit 2322.

The first feedback unit 2321 is configured to send a feedback including a number in the call request initiated by the second terminal device to the first terminal device, directly or through the server.

The second feedback unit 2322 is configured to detect whether the number in the call request initiated by the second terminal device is a number of the first terminal device, and send a feedback including the detecting result to the first terminal device, directly or through the server.

Referring back to FIG. 23, the terminating request receiving module 2330 is configured to receive a terminating request sent by the first terminal device. The terminating request is sent to the second terminal device by the first terminal device if the feedback indicates that the second terminal device is calling the first terminal device.

The terminating request processing module 2340 is configured to terminate the call request of the second terminal device according to the terminating request received by the terminating request receiving module 2330.

The device 2300 allows the second terminal device to receive a number query request, send a feedback to the first terminal device in response to the number query request, and receive a terminating request to terminate a call request initiated by the second terminal so as to establish a communication. In doing so, if two terminal devices initiate call requests to each other, the call request initiated by the second terminal device may be terminated so as to establish communication between the two terminal devices.

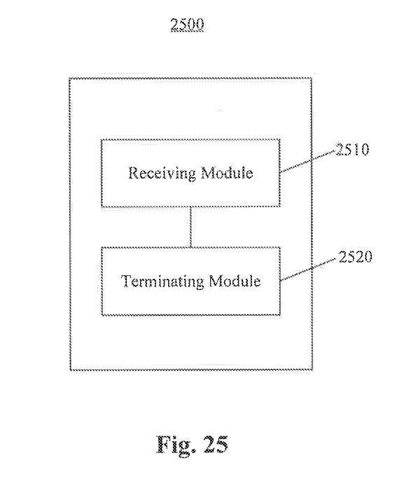

FIG. 25 is a block diagram of a device 2500 for handling a busy line, according to an exemplary embodiment. The device 2500 may be implemented to be all or a part of a second terminal device by hardware, software, or a combination thereof. Referring to FIG. 25, the device 2500 may include a receiving module 2510 and a terminating module 2520.

The receiving module 2510 is configured to receive a terminating request sent by a first terminal device. The terminating request is sent to the second terminal device by the first terminal device if the first terminal device receives a feedback from a server indicating that the second terminal device is calling the first terminal device. The feedback is in response to a number query request which is sent to the server by the first terminal device if the second terminal device is in a busy state.

The terminating module 2520 is configured to terminate the call request of the second terminal device according to the terminating request received by the receiving module 2510.

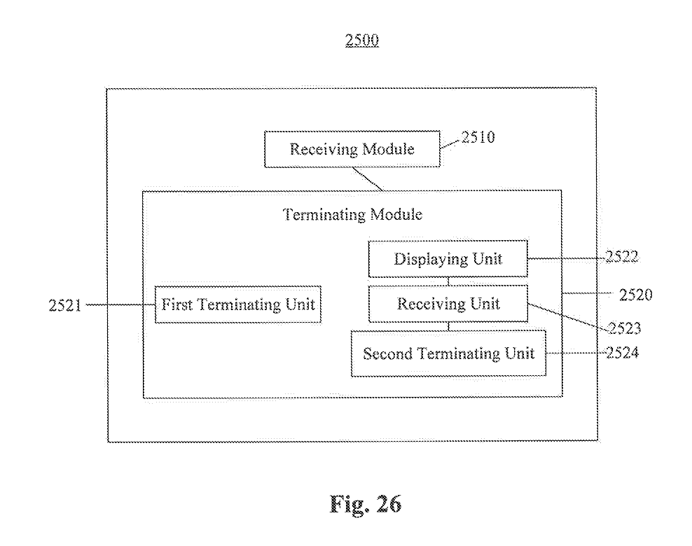

In one exemplary embodiment, shown in FIG. 26, the terminating module 2520 may include a first terminating unit 2521. The first terminating unit 2521 is configured to terminate the call request automatically if a terminating request is received.

In some embodiments, the terminating module 2520 may include a displaying unit 2522. The displaying unit 2522 is configured to display the terminating request if a terminating request is received. The terminating module 2520 may also include a receiving unit 2523 configured to receive a user input signal on the terminating request. The terminating module 2520 may further include a second terminating unit 2524 configured to terminate the call request based on the user input signal received by the receiving unit 2523.

The device 2500 allows the second terminal device to terminate a call request according to terminating request, or to display the terminating request, receive a user input signal corresponding to the terminating request, and terminate the call request according to the user input signal. In doing so, the call request initiated by the second terminal device may be terminated, and communication between the two terminal devices may he established.

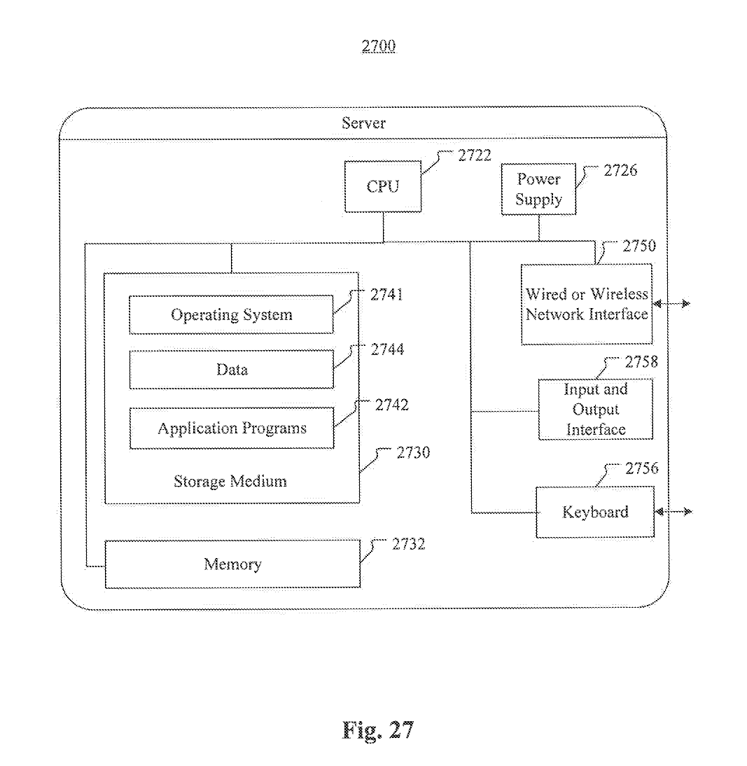

FIG. 27 is a block diagram of a server 2700, according to an exemplary embodiment. The server 2700 may include one or more central processing units (CPU) 2722 (e.g., one or more processors), a memory 2732, one or more storage mediums 2730 (e.g., one or more mass storage devices) for storing an operating system 2741, application programs 2742 or data 2744.

The memory 2732 and the storage mediums 2730 may be transitory or non-transitory. The application programs stored in the storage mediums 2730 may include one or more modules (not shown), and each module may include a series of instructions for the server. Furthermore, the central processing unit 2722 may be configured to communicate with the storage medium 2730 to execute the series of instructions stored in the storage medium 2730 on the server 2700.

The server 2700 may further include one or more power supplies 2726, one or more wired or wireless network interfaces 2750, one or more input and output interfaces 2758, one or more keyboards 2756, and/or one or more operating systems 2741, such as Windows Server™, Mac OS X™, Unix™, Linux™, FreeBSD™ and so on.

In exemplary embodiments, there is provided a non-transitory storage medium including instructions, such as included in the memory 2732, executable by the CPU 2722 in the server 2700, for performing the above described methods for handling a busy line. For example, the storage medium may be a read-only memory, a disc, a CD-ROM, etc.

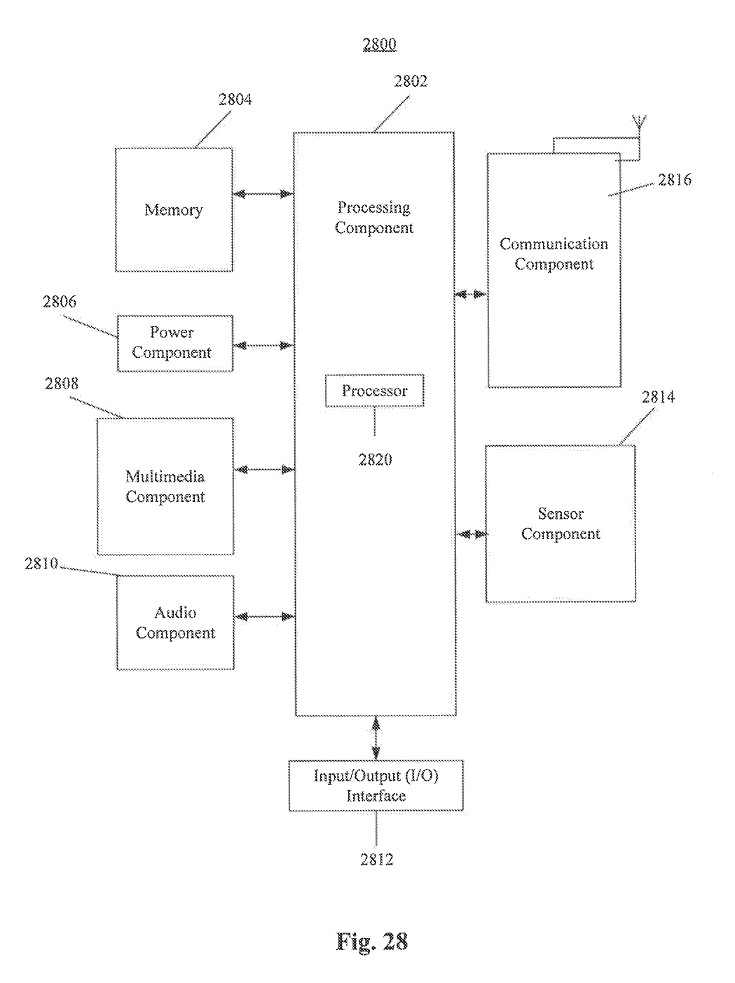

FIG. 28 is a block diagram of a terminal device 2800, according to an exemplary embodiment. For example, the terminal device 2800 may be a mobile phone, a computer, a digital broadcasting terminal, a message receiving and sending equipment, a game controller, a tablet device, a medical equipment, a fitness equipment, a PDA and so on.

Referring to FIG. 28, the terminal device 2800 may include one or more of the following components: a processing component 2802, a memory 2804, a power component 2806, a multimedia component 2808, an audio component 2810, an input/output (I/O) interface 2812, a sensor component 2814, and a communication component 2816. The person skilled in the art should appreciate that the structure of the terminal device 2800 as shown in FIG. 28 does not intend to limit the terminal device 2800. The terminal device 2800 may include more or less components or combine some components or other different components.

The processing component 2802 typically controls overall operations of the terminal device 2800, such as the operations associated with display, telephone calls, data communications, camera operations, and recording operations. The processing component 2802 may include one or more processors 2820 to execute instructions to perform all or part of the steps in the above described methods. Moreover, the processing component 2802 may include one or more modules which facilitate the interaction between the processing component 2802 and other components. For instance, the processing component 2802 may include a multimedia module to facilitate the interaction between the multimedia component 2808 and the processing component 2802.

The memory 2804 is configured to store various types of data to support the operation of the terminal device 2800. Examples of such data include instructions for any applications or methods operated on the terminal device 2800, contact data, phonebook data, messages, pictures, videos, etc. The memory 2804 is also configured to store programs and modules. The processing component 2802 performs various functions and data processing by operating programs and modules stored in the memory 2804. The memory 2804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2806 is configured to provide power to various components of the terminal device 2800. The power component 2806 may include a power management system, one or more power sources, and/or any other components associated with the generation, management, and distribution of power in the terminal device 2800.

The multimedia component 2808 includes a screen providing an output interface between the terminal device 2800 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a duration and a pressure associated with the touch or swipe action. In some embodiments, the multimedia component 2808 includes a front camera and/or a rear camera. The front camera and the rear camera may receive an external multimedia datum while the terminal device 2800 is in an operation mode, such as a photographing mode or a video mode. Each of the front camera and the rear camera may he a fixed optical lens system or have focus and optical zoom capability.

The audio component 2810 is configured to output and/or input an audio signal. For example, the audio component 2810 may include a microphone configured to receive an external audio signal when the terminal device 2800 is in an operation mode, such as a call mode, a recording mode, and/or a voice recognition mode. The received audio signal may be further stored in the memory 2804 or transmitted via the communication component 2816. In some embodiments, the audio component 2810 includes a speaker to output audio signals.

The I/O interface 2812 provides an interface between the processing component 2802 and peripheral interface modules, such as a keyboard, a click, wheel, buttons, and the like. The buttons may include, but are not limited to, a home button, a volume button, a starting button, and/or a locking button.

The sensor component 2814 includes one or more sensors to provide status assessments of various aspects of the terminal device 2800. For instance, the sensor component 2814 may detect an on/off status of the terminal 2800, relative positioning of components (e.g., the display and the keypad) of the terminal 2800, a change in position of the terminal 2800 or a component of the terminal 2800, a presence or absence of user contact with the terminal device 2800, an orientation or an acceleration/deceleration of the terminal device 2800, and/or a change in temperature of the terminal device 2800. The sensor component 2814 may include a proximity sensor configured to detect the presence of nearby objects without any physical contact. The sensor component 2814 may also include a light sensor, such as a CMOS or CCD image sensor, for use in imaging applications. In some embodiments, the sensor component 2814 may also include an accelerometer sensor, a gyroscope sensor, a magnetic sensor, a pressure sensor, or a temperature sensor.

The communication component 2816 is configured to facilitate wired or wireless communication between the terminal device 2800 and other devices. The terminal device 2800 can access a wireless network based on a communication standard, such as WiFi, 2G, or 3G, or a combination thereof. In one exemplary embodiment, the communication component 2816 receives a broadcast signal or information from an external broadcast management system via a broadcast channel. In one exemplary embodiment, the communication component 2816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the terminal device 2800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 2804 including instructions, and the instructions are executable by the processor 2820 of the terminal device 2800, for performing the above-described methods. For example, the non-transitory computer-readable storage medium may be a ROM, a RAM (random access memory), a CD-ROM, a magnetic tape, a floppy disc, an optical data storage device, and the like.

It should be understood by those skilled in the art that the above described methods, devices, and modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the invention being indicated by the following claims.

It should be understood that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a first terminal device to handle a busy line, comprising:
sending a number query request when a second terminal device to which the first terminal device initiates a first call request is in a busy state;
receiving a feedback on the number query request, wherein the feedback is provided based on a second call request initiated by the second terminal device; and
if the feedback indicates that the second terminal device is calling the first terminal device, sending a connecting request to a server or sending a terminating request to one of the server and the second terminal device, wherein the connecting request indicates a request to connect the first terminal device with the second terminal device, and the terminating request indicates a request to terminate the second call request initiated by the second terminal device.

2. The method according to claim 1, wherein the feedback includes a number in the second call request initiated by the second terminal device or a detecting result indicating whether the number in the second call request initiated by the second terminal device is a number associated with the first terminal device.

3. A method for handling a busy line, comprising:
receiving a number query request sent by a first terminal device, wherein the number query request is sent by the first terminal device when a second terminal device to which the first terminal device initiates a first call request is in a busy state; and
sending a feedback to the first terminal device based on a second call request initiated by the second terminal device, wherein the feedback indicates that the second terminal device is calling the first terminal device.

4. The method according to claim 3, further comprising:
detecting whether a number in the second call request initiated by the second terminal device is a number associated with the first terminal device; and
sending a detecting result in the feedback to the first terminal device.

5. The method according to claim 3, further comprising;
receiving a connecting request sent by the first terminal device, wherein the connecting request is sent to a server by the first terminal device when the first terminal device receives the feedback indicating that the second terminal device is calling the first terminal device; and
connecting the first terminal device with the second terminal device in response to the connecting request.

6. The method according to claim 3, further comprising:
receiving a terminating request sent by the first terminal device, wherein the terminating request is sent to a server by the first terminal device when the first terminal device receives the feedback indicating that the second terminal device is calling the first terminal device; and
terminating the second call request initiated by the second terminal device in response to the terminating request.

7. The method according to claim 6, further comprising:
sending a termination indication message to the second terminal device, wherein the termination indication message notifies the second terminal device not to continue initiating the second call request.

8. The method according to claim 3, further comprising:
receiving a terminating request sent by the first terminal device, wherein the terminating request is sent to the second terminal device by the first terminal device when the first terminal device receives the feedback indicating that the second terminal device is calling the first terminal device; and
terminating the second call request of the second terminal device in response to the terminating request.

9. A method for handling a busy line, comprising:
receiving a terminating request sent by a first terminal device, wherein the terminating request is sent to a second terminal device by the first terminal device when a feedback received by the first terminal device from a server indicates that the second terminal device is calling the first terminal device; and
terminating a call request initiated by the second terminal device in response to the terminating request.

10. The method according to claim 9, further comprising:
displaying the terminating request;
receiving a user input signal on the terminating request; and
terminating the call request based on the user input signal.

11. A first terminal device, comprising:
a processor; and
a memory for storing instructions executable by the processor;
wherein the processor is configured to:
send a number query request when a second terminal device to which the first terminal device initiates a first call request is in a busy state;
receive a feedback on the number query request, wherein the feedback is provided based on a second call request initiated by the second terminal device;
if the feedback indicates that the second terminal device is calling the first terminal device, send a connecting request to a server or send a terminating request to one of the server and the second terminal device, wherein the connecting request indicates a request to connect the first terminal device with the second terminal device, and the terminating request indicates a request to terminate the second call request initiated by the second terminal device.

12. The first terminal device according to claim 11, wherein the feedback includes a number in the second call request initiated by the second terminal device or a detecting result indicating whether the number in the second call request initiated by the second terminal device is a number associated with the first terminal device.

13. A server, comprising:
a processor; and
a memory for storing instructions executable by the processor;
wherein the processor is configured to:
receive a number query request sent by a first terminal device, wherein the number query request is sent by the first terminal device when a second terminal device to which the first terminal device initiates a first call request is in a busy state; and
send a feedback to the first terminal device based on a second call request initiated by the second terminal device, wherein the feedback indicates that the second terminal device is calling the first terminal device.

14. The server according to claim 13, wherein the processor is further configured to:
detect whether the number in the second call request initiated by the second terminal device is a number associated with the first terminal device; and
send a detecting result in the feedback to the first terminal device.

15. The server according to claim 13, wherein the processor is further configured to:
receive a connecting request sent by the first terminal device, wherein the connecting request is sent to the server by the first terminal device when the first terminal device receives the feedback indicating that the second terminal device is calling the first terminal device; and
connect the first terminal device with the second terminal device in response to the connecting request.

16. The server according to claim 13, wherein the processor is further configured to
receive a terminating request sent by the first terminal device, wherein the terminating request is sent to the server by the first terminal device when the first terminal device receives the feedback indicating that the second terminal device is calling the first terminal device; and
terminate the second call request initiated by the second terminal device in response to the terminating request.

17. The server according to claim 16, wherein the processor is further configured to:
send a termination indication message to the second terminal device, wherein the termination indication message notifies the second terminal device not to continue initiating the second call request.

18. The server according to claim 13, wherein the processor is further configured to:
receive a terminating request sent by the first terminal device, wherein the terminating request is sent to the second terminal device by the first terminal device when the first terminal device receives the feedback indicating that the second terminal device is calling the first terminal device; and
terminate the second call request of the second terminal device in response to the terminating request.

19. A second terminal device, comprising:
a processor; and
a memory for storing instructions executable by the processor;
wherein the processor is configured to:
receive a terminating request sent by a first terminal device, wherein the terminating request is sent to the second terminal device by the first terminal device when a feedback received by the first terminal device from a server indicates that the second terminal device is calling the first terminal device; and
terminate a call request initiated by the second terminal device in response to the terminating request.

20. The second terminal device according to claim 19, wherein the processor is further configured to:
display the terminating request;
receive a user input signal on the terminating request; and
terminate the call request based on the user input signal.
